(19) United States
(12) Patent Application Publication
(10) Pub. No.: US 2023/0265889 A1
(43) Pub. Date: Aug. 24, 2023

(54) SUPPORT STRUCTURE AND INDUSTRIAL MACHINE

(71) Applicant: FANUC CORPORATION, Minamitsuru-gun, Yamanashi (JP)

(72) Inventors: Keisuke SUGAHARA, Minamitsuru-gun, Yamanashi-ken (JP); Satoshi YANO, Minamitsuru-gun, Yamanashi-ken (JP)

(73) Assignee: FANUC CORPORATION, Minamitsuru-gun, Yamanashi (JP)

(21) Appl. No.: 18/006,793

(22) PCT Filed: Jul. 21, 2021
(86) PCT No.: PCT/JP2021/027258

§ 371 Date: Jan. 25, 2023

(30) Foreign Application Priority Data
Jul. 27, 2020 (JP) 2020-126089

(51) Int. Cl. F16C 35/063; F16C 35/067; F16H 55/36; F16H 55/56

(52) U.S. Cl. CPC F16C 35/063; F16C 35/067; F16H 55/36; F16H 55/56; F16C 2322/00

(57) ABSTRACT

Provided are a support structure whereby the load on a motor drive shaft or bearing can be reduced, and an industrial machine. The support structure according to an embodiment of the present invention comprises a bearing (112) positioned between a motor (102) and a drive pulley (104), and a bearing holder (114) provided to the motor (102). An inner race (120) of the bearing (112) is fixed to the drive pulley (104) so as to be incapable of sliding in the axial direction of a drive shaft (102S), and an outer race (122) of the bearing (112) is allowed to move in the axial direction between the bearing holder (114) and the drive pulley (104).

### TECHNICAL FIELD

The present invention relates to a support structure for supporting a drive pulley that rotates integrally with a drive shaft of a motor, and an industrial machine including the support structure.

### BACKGROUND ART

JP 2012-161995 A discloses a power transmission device including a motor fixed to a motor bracket, a drive pulley coupled to a drive shaft of the motor, a driven pulley fixed to a holding plate, and a belt wound around the drive pulley and the driven pulley.

In the power transmission device disclosed in JP 2012-161995 A, the drive shaft of the motor extends through the motor bracket. A bearing that rotatably supports the drive pulley is provided at a tip portion of the drive shaft of the motor. A bearing holder that supports the bearing is attached to the motor bracket so as to cover the periphery of the drive pulley.

### SUMMARY OF THE INVENTION

However, in the power transmission device disclosed in JP 2012-161995 A, since the periphery of the drive pulley is covered with the bearing holder, heat generated between the motor or the drive pulley and the belt is not easily released to the outside. Therefore, the drive pulley tends to thermally expand. When the drive pulley thermally expands, the radial load received by the bearing and the drive shaft of the motor increases, and the life of the motor and the bearing tends to be shortened.

Therefore, the present invention provides a support structure and an industrial machine capable of reducing a load on a bearing and a drive shaft of a motor.

According to a first aspect of the present invention, there is provided a support structure that supports a drive pulley attached to a drive shaft of a motor and configured to rotate integrally with the drive shaft, the support structure comprising: a bearing disposed between the motor and the drive pulley and configured to support a radial load; and a bearing holder provided on the motor and configured to support the bearing, wherein an inner ring of the bearing is fixed so as not to be slidable relative to the drive pulley in an axial direction of the drive shaft, and an outer ring of the bearing is allowed to move in the axial direction between the bearing holder and the drive pulley.

According to a second aspect of the present invention, there is provided an industrial machine comprising: the above-described support structure; the motor; and the drive pulley.

According to the aspects of the present invention, it is possible to reduce the load on the bearing and the drive shaft of the motor.

That is, since the bearing that supports the radial load is disposed between the motor and the drive pulley, the bearing holder can be provided without covering the periphery of the drive pulley. Accordingly, heat generated between the motor or the drive pulley and the belt can be more easily released to the outside than in the case of covering the periphery of the drive pulley, and thermal expansion of the drive pulley can be suppressed. Therefore, it is possible to suppress an increase in the radial load received by the bearing and the drive shaft of the motor.

Further, since the movement of the outer ring of the bearing in the axial direction between the bearing holder and the drive pulley is allowed, the expansion and contraction of the drive shaft of the motor in the axial direction due to the temperature change can be released together with the bearing as compared with a case where the movement is not allowed.

In this manner, it is possible to prevent an excessive force from being applied to the bearing and the drive shaft of the motor, and as a result, it is possible to reduce the load on the bearing and the drive shaft of the motor.

### BRIEF DESCRIPTION OF DRAWINGS

FIG. 1 is a schematic view showing an industrial machine according to an embodiment of the present invention;

FIG. 2 is a schematic view showing a power transmission device according to the embodiment;

FIG. 3 is a cross-sectional view taken along line III-III of FIG. 2;

FIG. 4 is a diagram showing the power transmission device from the same viewpoint as FIG. 3; and

FIG. 5 is a diagram showing the power transmission device from the same viewpoint as FIG. 3.

### DETAILED DESCRIPTION OF THE INVENTION

A preferred embodiment of the present invention will be presented and described in detail below with reference to the accompanying drawings.

### Embodiment

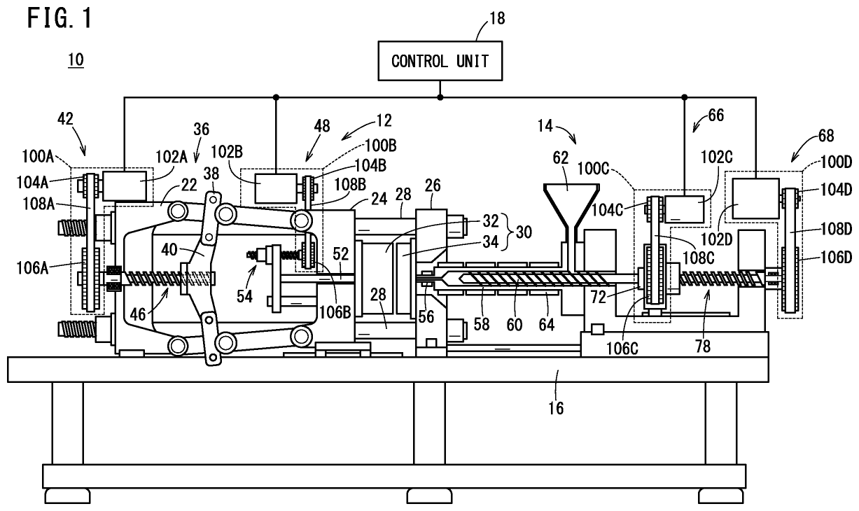

FIG. 1 is a schematic view of an industrial machine 10 according to an embodiment of the present invention. In this instance, a case where the industrial machine 10 is an injection molding machine will be described as an example, but the industrial machine 10 is not limited thereto.

The industrial machine 10 is provided with a clamping device 12 and an injection device 14. The clamping device 12 and the injection device 14 are installed on a base 16. The industrial machine 10 is further provided with a control unit (control device) 18 that controls the clamping device 12 and the injection device 14.

The clamping device 12 is provided with a rear platen 22, a movable platen 24, and a stationary platen 26. The movable platen 24 is capable of moving forward and backward along a tie bar 28 provided between the rear platen 22 and the stationary platen 26.

A mold 30 is provided between the movable platen 24 and the stationary platen 26. The mold 30 includes a movable mold 32 and a stationary mold 34. The movable mold 32 is attached to the movable platen 24. The stationary mold 34 is attached to the stationary platen 26.

A toggle link 36 is provided between the rear platen 22 and the movable platen 24. The toggle link 36 is connected to a cross head 40 via a cross link 38.

The clamping device 12 is further provided with a mold opening/closing mechanism 42. The mold opening/closing mechanism 42 is capable of moving the movable platen 24 forward and backward with respect to the stationary platen 26. The mold opening/closing mechanism 42 is provided with a power transmission device 100A. The power transmission device 100A is provided with a motor (mold opening/closing motor) 102A, a drive pulley 104A, a driven pulley 106A, and a belt 108A. Reference numeral 100 is used to describe the power transmission device as a collective term, and reference numerals 100A to 100D are used to describe the individual power transmission devices. Reference numeral 102 is used to describe the motor as a collective term, and reference numerals 102A to 102D are used to describe the individual motors. Reference numeral 104 is used to describe the drive pulley as a collective term, and reference numerals 104A to 104D are used to describe the individual drive pulleys. Reference numeral 106 is used to describe the driven pulley as a collective term, and reference numerals 106A to 106D are used to describe the individual driven pulleys. Reference numeral 108 is used to describe the belt as a collective term, and reference numerals 108A to 108D are used to describe the individual belts.

The drive pulley 104A is fixed to a drive shaft of the motor 102A. The drive pulley 104A rotates together with the motor 102A. The belt 108A is wound around the drive pulley 104A and the driven pulley 106A. The driven pulley 106A rotates based on the rotational force of the drive pulley 104A transmitted by the belt 108A. The driving of the motor 102A can be controlled by the control unit 18.

Rotational motion of the motor 102A is transmitted to a ball screw mechanism 46 that is connected to the cross head 40. The rotational motion transmitted from the motor 102A is converted by the ball screw mechanism 46 into a forward/backward motion of the cross head 40. The forward/backward motion of the cross head 40 is transmitted to the movable platen 24 via the toggle link 36. In this manner, the movable platen 24 can be moved forward and backward with respect to the stationary platen 26.

The clamping device 12 is provided with an ejector mechanism 48. The ejector mechanism 48 serves to take out a molded product from the movable mold 32. The ejector mechanism 48 is provided with the power transmission device 100B. The power transmission device 100B is provided with the motor (ejector motor) 102B, the drive pulley 104B, the driven pulley 106B, and the belt 108B.

The drive pulley 104B is fixed to a drive shaft of the motor 102B. The drive pulley 104B rotates together with the motor 102B. The belt 108B is wound around the drive pulley 104B and the driven pulley 106B. The driven pulley 106B rotates based on the rotational force of the drive pulley 104B transmitted by the belt 108B. The driving of the motor 102B can be controlled by the control unit 18.

Rotational motion of the motor 102B is transmitted to a ball screw mechanism 54 that is connected to an ejector pin 52. The rotational motion transmitted from the motor 102B is converted by the ball screw mechanism 54 into a forward/backward motion of the ejector pin 52. In this manner, the ejector pin 52 can be moved forward and backward with respect to the movable platen 24. By the ejector pin 52 being moved to the movable platen 24 side, the molded product is ejected from the movable mold 32, and the molded product is taken out.

The injection device 14 is provided with a nozzle 56, a cylinder 58, a screw 60, a hopper 62, and a heater 64. The nozzle 56 is provided at a tip of the cylinder 58. The cylinder 58 is constituted by a hollow member. The screw 60 is inserted through the cylinder 58. The cylinder 58 and the screw 60 extend along the opening/closing direction of the mold 30. The hopper 62 is connected to the cylinder 58. The hopper 62 serves to introduce a resin material into the cylinder 58. In a case where the resin material, which is introduced from the hopper 62, is in the form of pellets, the resin material is melted by the heater 64.

The injection device 14 is provided with a resin supply mechanism 66, and an injection mechanism 68. The resin supply mechanism 66 delivers the resin material inside the cylinder 58 toward the nozzle 56 of the cylinder 58. The injection mechanism 68 injects the resin material toward the mold 30. The resin supply mechanism 66 is provided with the power transmission device 100C. The power transmission device 100C is provided with the motor (rotational motion motor) 102C, the drive pulley 104C, the driven pulley 106C, and the belt 108C.

The drive pulley 104C is fixed to a drive shaft of the motor 102C. The drive pulley 104C rotates together with the motor 102C. The belt 108C is wound around the drive pulley 104C and the driven pulley 106C. The driven pulley 106C rotates based on the rotational force of the drive pulley 104C transmitted by the belt 108C. The driving of the motor 102C can be controlled by the control unit 18.

Rotational motion of the motor 102C is transmitted to a bush 72 that is connected to the screw 60, and as a result, the screw 60 rotates about its axis. When the screw 60 rotates about its axis, the resin material inside the cylinder 58 is delivered toward the nozzle 56 of the cylinder 58.

The injection mechanism 68 is provided with the power transmission device 100D. The power transmission device 100D is provided with the motor (linear motion motor) 102D, the drive pulley 104D, the driven pulley 106D, and the belt 108D.

The drive pulley 104D is fixed to a drive shaft of the motor 102D. The drive pulley 104D rotates together with the motor 102D. The belt 108D is wound around the drive pulley 104D and the driven pulley 106D. The driven pulley 106D rotates based on the rotational force of the drive pulley 104D transmitted by the belt 108D. The driving of the motor 102D can be controlled by the control unit 18.

Rotational motion of the motor 102D is converted by a ball screw mechanism 78 into a forward/backward motion of the bush 72, and this forward/backward motion is transmitted to the screw 60. As a result, the screw 60 moves in the axial direction. When the screw 60 moves in the direction toward the nozzle 56, the resin material inside the cylinder 58 is injected from the nozzle 56 toward the mold 30.

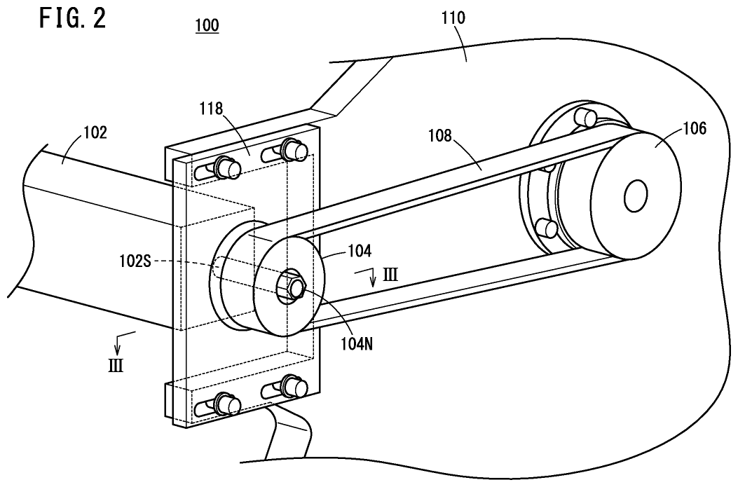

Hereinafter, the support structure of the drive pulley 104 of the power transmission device 100 as the collective term will be described. FIG. 2 is a schematic view showing the power transmission device 100 according to the embodiment. As shown in FIG. 2, the power transmission device 100 is provided with the motor 102, the drive pulley 104, the driven pulley 106, and the belt 108.

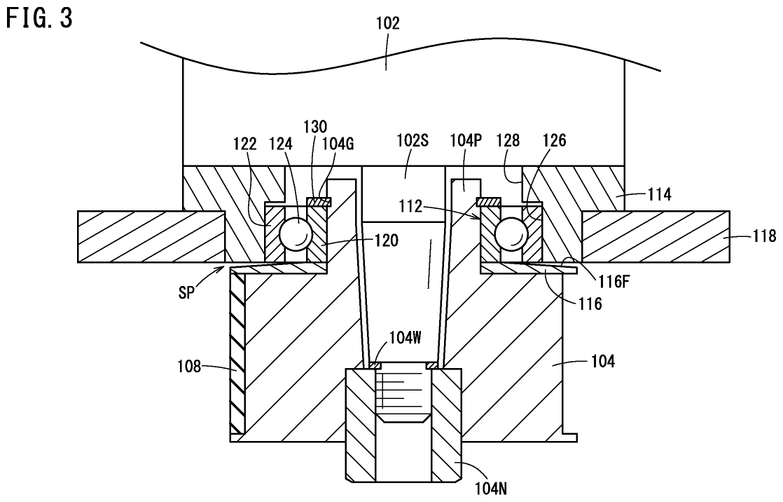

The motor 102 is provided on a holding plate 110. The motor 102 may be provided to be movable with respect to the holding plate 110. In the present embodiment, the motor 102 is provided to be movable with respect to the holding plate 110. The drive pulley 104 is fixed to a drive shaft 102S of the motor 102. The drive pulley 104 is fixed to the drive shaft 102S by a fastener 104N. Therefore, the drive pulley 104 rotates together with the motor 102. In FIG. 2, a pulley nut is illustrated as the fastener 104N. The drive pulley 104 is fixed to the drive shaft 102S by the fastener 104N (pulley nut) via a washer 104W (see FIG. 3). The driven pulley 106 is fixed to the holding plate 110. The belt 108 is wound around the drive pulley 104 and the driven pulley 106. The driven pulley 106 rotates based on the rotational force of the drive pulley 104 transmitted by the belt 108.

The diameter of the drive pulley 104 may be smaller than the diameter of the driven pulley 106, may be larger than the diameter of the driven pulley 106, or may be the same as the diameter of the driven pulley 106. The number of the belts 108 wound around the drive pulley 104 and the driven pulley 106 may be one or more. FIG. 2 illustrates a case where the diameter of the drive pulley 104 is smaller than the diameter of the driven pulley 106, and the number of the belts 108 wound around the drive pulley 104 and the driven pulley 106 is one. The belt 108 may be provided with a plurality of teeth at intervals in the extending direction of the belt 108 or may not be provided with the teeth.

FIG. 3 is a cross-sectional view taken along line III-III of FIG. 2. As shown in FIG. 3, the support structure of the drive pulley 104 includes a bearing 112, a bearing holder 114, a contact plate 116, and a motor bracket 118.

The bearing 112 is a rolling bearing that supports a radial load. The number of the bearings 112 may be one or more. When a plurality of the bearings 112 are provided, a spacer may be provided between the bearing 112 and the bearing 112. In the present embodiment, one bearing 112 is provided. The bearing 112 includes an inner ring 120, an outer ring 122, and a plurality of rolling elements 124 rollably interposed between the inner ring 120 and the outer ring 122. Specific examples of the bearing 112 include a ball bearing and the like. The bearing 112 is disposed between the motor 102 and the drive pulley 104.

The bearing holder 114 serves to support the bearing 112 and is provided on the motor 102. The bearing holder 114 may be formed integrally with a motor housing of the motor 102 or may be formed separately from the motor housing of the motor 102. When the bearing holder 114 is formed separately from the motor housing of the motor 102, the bearing holder 114 is fixed to the motor housing by a fastener such as a bolt. The bearing holder 114 is disposed on an end surface of the motor housing through which the drive shaft 102S of the motor 102 passes.

The bearing holder 114 is formed with a bearing accommodating portion 126 for accommodating the bearing 112, and a shaft insertion hole 128 through which the drive shaft 102S of the motor 102 is inserted. The bearing accommodating portion 126 is formed on the surface of the bearing holder 114 on the drive pulley 104 side, and the bearing accommodating portion 126 is recessed toward the motor 102. The shaft insertion hole 128 passes through the bearing holder 114 from the bottom surface of the bearing accommodating portion 126 to the surface of the bearing holder 114 on the motor 102 side. The shaft insertion hole 128 has a diameter larger than the outer diameter of the inner ring 120 of the bearing 112 and smaller than the outer diameter of the outer ring 122 of the bearing 112.

A protruding portion 104P of the drive pulley 104 is disposed in the bearing accommodating portion 126. The protruding portion 104P protrudes from the surface of the drive pulley 104 that faces the bearing holder 114 toward the bearing accommodating portion 126. The protruding portion 104P is inserted through the inner ring 120 of the bearing 112 accommodated in the bearing accommodating portion 126, and the inner ring 120 is fitted to the protruding portion 104P. Therefore, the inner ring 120 of the bearing 112 accommodated in the bearing accommodating portion 126 rotates together with the drive pulley 104. The outer ring 122 of the bearing 112 accommodated in the bearing accommodating portion 126 is clearance-fitted to the bearing accommodating portion 126. The outer ring 122 of the bearing 112 accommodated in the bearing accommodating portion 126 is slidable in the axial direction of the drive shaft 102S.

The drive shaft 102S of the motor 102 passes through the protruding portion 104P. An end portion of the protruding portion 104P on the motor 102 side is disposed in the shaft insertion hole 128 of the bearing holder 114. An annular groove 104G is formed on the outer peripheral surface of the end portion of the protruding portion 104P on the motor 102 side. A retaining ring 130 is fitted into the annular groove 104G.

The retaining ring 130 is a stopper member that is in contact with the surface of the inner ring 120 of the bearing 112 on the motor 102 side. The retaining ring 130 restricts sliding of the inner ring 120 toward the motor 102. Note that the surface of the outer ring 122 of the bearing 112 on the motor 102 side is not in contact with the bottom surface of the bearing accommodating portion 126. A clearance is formed between the bottom surface of the bearing accommodating portion 126 and the surface of the outer ring 122 of the bearing 112 that faces the motor 102. This clearance is larger than a clearance between the surface of the outer ring 122 and the surface of the bearing accommodating portion 126 which are clearance-fitted to each other.

The contact plate 116 restricts sliding of the inner ring 120 in the axial direction toward the drive pulley 104, and is provided on the drive pulley 104. The contact plate 116 may be formed integrally with the drive pulley 104 or may be formed separately from the drive pulley 104. When the contact plate 116 is formed separately from the drive pulley 104, the contact plate 116 may be fixed by being sandwiched between the inner ring 120 of the bearing 112 and the drive pulley 104, or may be fixed to the drive pulley 104 by a fastener such as a bolt.

The contact plate 116 includes at least a portion that is in contact with the surface of the inner ring 120 of the bearing 112 on the drive pulley 104 side. Note that the contact plate 116 may be disposed on the inner side of the outer ring 122 of the bearing 112, or may extend from the outer ring 122 toward the outer side in the radial direction of the drive pulley 104. When the contact plate 116 extends from the outer ring 122 of the bearing 112 toward the outer side in the radial direction of the drive pulley 104, the contact plate 116 is not in contact with the surface of the outer ring 122 on the drive pulley 104 side.

In the present embodiment, the contact plate 116 protrudes further outward than the circumferential surface of the drive pulley 104 around which the belt 108 is wound. In addition, in the present embodiment, the contact plate 116 has an inclined surface 116F that is inclined so as to be farther away from the bearing 112 toward the outer side in the radial direction of the drive pulley 104. Due to the presence of the inclined surface 116F, a clearance SP is formed between the contact plate 116 and the outer ring 122. As a result, the contact plate 116 is not in contact with the surface of the outer ring 122 on the drive pulley 104 side. Note that the contact plate 116 is not limited to the shape of the present embodiment as long as the contact plate 116 is not in contact with the surface of the outer ring 122 on the drive pulley 104 side.

The motor bracket 118 is provided on the holding plate 110 so as to be slidable along a direction in which the drive pulley 104 approaches or separates from the driven pulley 106 (see FIG. 2). The bearing holder 114 is provided on the motor bracket 118. Therefore, the bearing holder 114, the motor 102 on which the bearing holder 114 is provided, the drive pulley 104 fixed to the drive shaft 102S of the motor 102, and the contact plate 116 provided on the drive pulley 104 move together with the motor bracket 118.

The bearing holder 114 may be formed integrally with the motor bracket 118, or may be formed separately from the motor bracket 118. When the bearing holder 114 is formed separately from the motor bracket 118, the bearing holder 114 is fixed to the motor bracket 118 by a fastener such as a bolt.

As described above, in the support structure of the drive pulley 104 according to the present embodiment, the bearing 112 that supports the radial load is disposed between the motor 102 and the drive pulley 104. As a result, the bearing holder 114 can be provided without covering the periphery of the drive pulley 104. Therefore, heat generated between the motor 102 or the drive pulley 104 and the belt 108 can be more easily released to the outside than in the case of covering the periphery of the drive pulley as in JP 2012-161995 A. Therefore, thermal expansion of the drive pulley 104 can be suppressed. As a result, it is possible to suppress an increase in the radial load received by the bearing 112 and the drive shaft 102S of the motor 102. Further, as compared with the case of covering the periphery of the drive pulley as in JP 2012-161995 A, space saving can be achieved, and replacement and maintenance of the belt 108 can be easily performed.

Further, in the support structure of the drive pulley 104 according to the present embodiment, the inner ring 120 of the bearing 112 is fixed so as not to be slidable relative to the drive pulley 104 in the axial direction of the drive shaft 102S. On the other hand, the outer ring 122 of the bearing 112 is allowed to move in the axial direction of the drive shaft 102S between the bearing holder 114 and the drive pulley 104. As a result, as compared with a case where the movement of the drive shaft 102S in the axial direction is not allowed, the expansion and contraction of the drive shaft 102S in the axial direction due to the temperature change can be released together with the bearing 112.

As described above, according to the support structure of the drive pulley 104, an increase in the radial load on the bearing 112 caused by the thermal expansion of the drive pulley 104 can be suppressed, and in addiction, the expansion and contraction of the drive shaft 102S in the axial direction due to the temperature change can be released together with the bearing 112. Therefore, it is possible to prevent an excessive force from being applied to the bearing 112 or the drive shaft 102S of the motor 102. As a result, it is possible to reduce the load on the bearing 112 or the drive shaft 102S.

### [Modifications]

Although the preferred embodiment of the present invention has been described above, the present invention is not limited to the above-described embodiment, and various modifications can be made thereto within a range that does not depart from the essence and gist of the present invention.

For example, in the above-described embodiment, an exemplary case has been described in which the industrial machine 10 is an injection molding machine, but the present invention is not limited thereto. The present invention can be applied to various industrial machines 10 other than the injection molding machine, such as a machine tool, a robot, a mining machine, a woodworking machine, an agricultural machine, and a construction machine.

Further, in the above-described embodiment, an exemplary case has been described in which the power transmission device 100 is provided in the industrial machine 10, but the present invention is not limited thereto. The power transmission device 100 may be provided in any device. For example, the power transmission device 100 may be provided in a vehicle or the like.

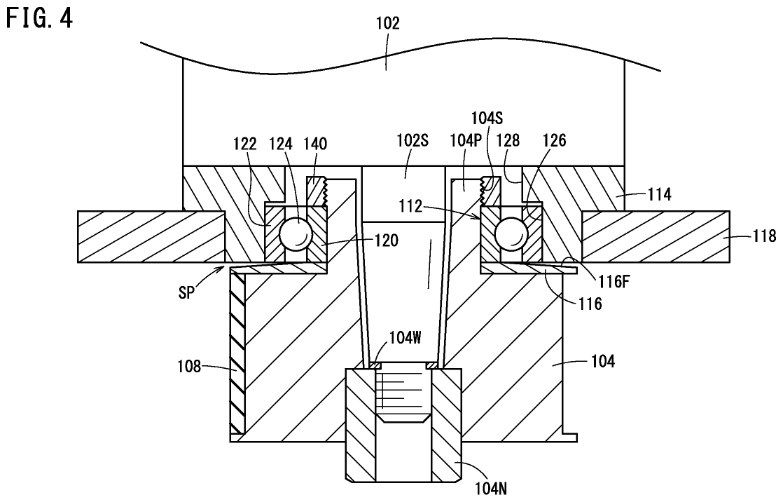

Further, in the above-described embodiment, as a stopper member that is in contact with the surface of the inner ring 120 of the bearing 112 on the motor 102 side, the retaining ring 130 fitted into the annular groove 104G of the protruding portion 104P of the drive pulley 104 is employed, but the present invention is not limited thereto. For example, as shown in FIG. 4, a nut 140 screwed to a thread groove 104S formed on the outer peripheral surface of the protruding portion 104P of the drive pulley 104 may be employed as the stopper member.

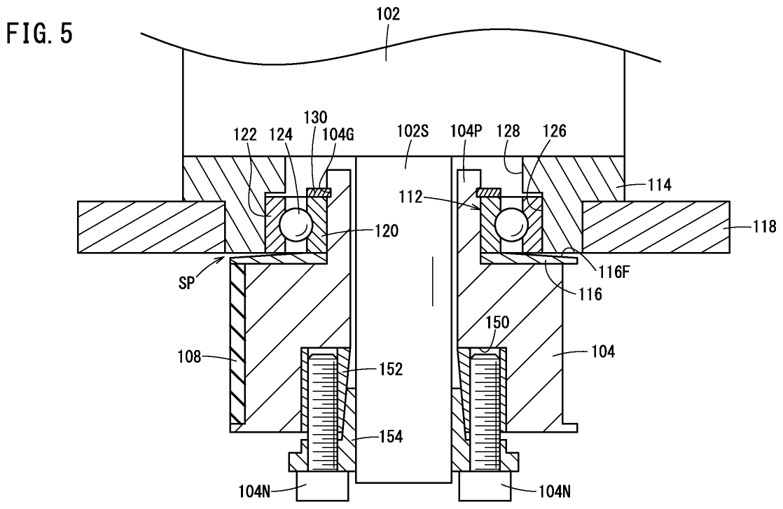

Further, in the above-described embodiment, the drive shaft 102S of the motor 102 having an outer diameter that becomes smaller toward the tip thereof is employed. Furthermore, in the above-described embodiment, the pulley nut is employed as the fastener 104N. However, for example, as shown in FIG. 5, the drive shaft 102S of the motor 102 having a substantially constant outer diameter may be employed. Further, a bolt may be employed as the fastener 104N. In the illustration of FIG. 5, a recessed portion 150 is formed on an end surface of the drive pulley 104 on the side opposite to the motor 102 side. An annular outer sleeve member 152 is fitted into the recessed portion 150. An annular convex portion of an inner sleeve member 154 is fitted between the outer sleeve member 152 and the drive shaft 102S inserted through the outer sleeve member 152. The inner sleeve member 154 and the outer sleeve member 152 are fixed to each other by the fasteners 104N (bolts). Note that the outer sleeve member 152 may be formed integrally with the drive pulley 104.

The above is summarized as follows.

According to a first aspect of the present invention, provided is the support structure that supports the drive pulley (104) fixed to the drive shaft (102S) of the motor (102) and configured to rotate integrally with the drive shaft (102S). The support structure includes the bearing (112) disposed between the motor (102) and the drive pulley (104) and configured to support a radial load, and the bearing holder (114) provided on the motor (102) and configured to support the bearing (112). The inner ring (120) of the bearing (112) is fixed so as not to be slidable relative to the drive pulley (104) in the axial direction of the drive shaft (102S), and the outer ring (122) of the bearing (112) is allowed to move in the axial direction between the bearing holder (114) and the drive pulley (104).

Since the bearing (112) supporting the radial load is disposed between the motor (102) and the drive pulley (104), the bearing holder (114) can be provided without covering the periphery of the drive pulley (104). Therefore, as compared with the case of covering the periphery of the drive pulley (104), heat generated between the motor (102) or the drive pulley (104) and the belt (108) can be more easily released to the outside, so that thermal expansion of the drive pulley (104) can be suppressed. Accordingly, it is possible to suppress an increase in the radial load received by the bearing (112) and the drive shaft (102S) of the motor (102). In addition, since movement of the outer ring (122) of the bearing (112) in the axial direction between the bearing holder (114) and the drive pulley (104) is allowed, expansion and contraction of the drive shaft (102S) in the axial direction due to the temperature change can be released together with the bearing (112) as compared with a case where such movement is not allowed. In this manner, it is possible to prevent an excessive force from being applied to the bearing (112) and the drive shaft (102S) of the motor (102), and as a result, it is possible to reduce the load on the bearing (112) and the drive shaft (102S) of the motor (102).

The support structure may include the contact plate (116) configured not to be in contact with the surface of the outer ring (122) of the bearing (112) on the drive pulley (104) side and configured to be in contact with the surface of the inner ring (120) of the bearing (112) on the drive pulley (104) side. As a result, by using the contact plate (116), it is possible to restrict the movement of the inner ring (120) of the bearing (112) in the axial direction and to allow the movement of the outer ring (122) of the bearing (112) in the axial direction.

The contact plate (116) may include the inclined surface (116F) that is inclined so as to be farther away from the bearing (112) toward the outer side in the radial direction of the drive pulley (104). As a result, the inclination angle of the inclined surface (116F) can be changed according to the type of the motor (102) and the bearing (112) or the like. Therefore, it is possible to appropriately set the clearance (SP) between the contact plate (116) and the surface of the outer ring (122) on the drive pulley (104) side without forming a complicated shape.

The contact plate (116) may protrude further outward than the circumferential surface of the drive pulley (104), the belt (108) being wound around the circumferential surface. As a result, it is possible to prevent the belt (108) from coming off the drive pulley (104) while allowing the outer ring (122) of the bearing (112) to move in the axial direction.

The contact plate (116) may be formed integrally with the drive pulley (104). As a result, the number of components can be reduced as compared with a case where the contact plate (116) is formed separately from the drive pulley (104).

The surface of the bearing holder (114) on the drive pulley (104) side may be formed with the bearing accommodating portion (126) recessed toward the motor (102) and configured to accommodate the bearing (112), and the outer ring (122) of the bearing (112) may be fitted in the bearing accommodating portion (126) in a state of not being in contact with the bottom surface of the bearing accommodating portion (126). This allows the outer ring (122) of the bearing (112) to move in the axial direction while supporting the radial load.

The drive pulley (104) may include the protruding portion (104P) protruding toward the bearing accommodating portion (126), and the protruding portion (104P) may be inserted through the inner ring (120) of the bearing (112), and the inner ring (120) may be fitted to the protruding portion (104P). As a result, it is possible to prevent the inner ring (120) from being displaced.

The support structure may include the stopper member configured to be in contact with the surface of the inner ring (120) of the bearing (112) on the motor (102) side. As a result, it is possible to prevent the inner ring (120) from being displaced.

The shaft insertion hole (128) through which the drive shaft (102S) is inserted and which has a diameter larger than the outer diameter of the inner ring (120) of the bearing (112) may be formed on the bottom surface side of the bearing accommodating portion (126), and the stopper member may be the retaining ring (130) fitted into the annular groove (104G) formed on the outer peripheral surface of the protruding portion (104P). As a result, it is possible to prevent the inner ring (120) from being displaced.

The shaft insertion hole (128) through which the drive shaft (102S) is inserted and which has a diameter larger than the outer diameter of the inner ring (120) of the bearing (112) may be formed on the bottom surface side of the bearing accommodating portion (126), and the stopper member may be the nut (140) screwed to the thread groove (104S) formed on the outer peripheral surface of the protruding portion (104P). As a result, it is possible to prevent the inner ring (120) from being displaced. In addition, the depth of the bearing accommodating portion (126) can be adjusted according to the type of the bearing (112).

The support structure may include the motor bracket (118) provided to be slidable along the direction in which the drive pulley (104) approaches or separates from the driven pulley (106) around which the belt (108) is wound together with the drive pulley (104), and the bearing holder (114) may be provided on the motor bracket (118) and movable together with the motor bracket (118). As a result, the tension of the belt (108) can be adjusted, and as a result, a radial load can be appropriately applied to the bearing (112).

The bearing holder (114) may be formed integrally with the motor bracket (118). As a result, the number of components can be reduced as compared with a case where the bearing holder (114) is formed separately from the motor bracket (118).

According to a second aspect of the present invention, provided is the industrial machine (10) including the above-described support structure, the motor (102), and the drive pulley (104). Since the industrial machine (10) includes the above-described support structure and the motor (102), it is possible to prevent an excessive force from being applied to the bearing (112) and the drive shaft (102S) of the motor (102), and as a result, it is possible to reduce the load on the bearing (112) and the drive shaft (102S) of the motor (102).

1. A support structure that supports a drive pulley fixed to a drive shaft of a motor and configured to rotate integrally with the drive shaft, the support structure comprising:
a bearing disposed between the motor and the drive pulley and configured to support a radial load; and
a bearing holder provided on the motor and configured to support the bearing, wherein
an inner ring of the bearing is fixed so as not to be slidable relative to the drive pulley in an axial direction of the drive shaft, and
an outer ring of the bearing is allowed to move in the axial direction between the bearing holder and the drive pulley.

2. The support structure according to claim 1, further comprising
a contact plate configured not to be in contact with a surface of the outer ring of the bearing on a side of the drive pulley and configured to be in contact with a surface of the inner ring of the bearing on the side of the drive pulley.

3. The support structure according to claim 2, wherein
the contact plate includes an inclined surface that is inclined so as to be farther away from the bearing toward an outer side in a radial direction of the drive pulley.

4. The support structure according to claim 2, wherein
the contact plate protrudes further outward than a circumferential surface of the drive pulley, a belt being wound around the circumferential surface.

5. The support structure according to claim 2, wherein
the contact plate is formed integrally with the drive pulley.

6. The support structure according to claim 1, wherein
a surface of the bearing holder on a side of the drive pulley is formed with a bearing accommodating portion recessed toward the motor and configured to accommodate the bearing, and
the outer ring of the bearing is fitted in the bearing accommodating portion in a state of not being in contact with a bottom surface of the bearing accommodating portion.

7. The support structure according to claim 6, wherein
the drive pulley includes a protruding portion protruding toward the bearing accommodating portion, and
the protruding portion is inserted through the inner ring of the bearing, and the inner ring is fitted to the protruding portion.

8. The support structure according to claim 7, further comprising
a stopper member configured to be in contact with a surface of the inner ring of the bearing on a side of the motor.

9. The support structure according to claim 8, wherein
a shaft insertion hole through which the drive shaft is inserted and which has a diameter larger than an outer diameter of the inner ring of the bearing is formed on a side of the bottom surface of the bearing accommodating portion, and
the stopper member is a retaining ring fitted into an annular groove formed on an outer peripheral surface of the protruding portion.

10. The support structure according to claim 8, wherein
a shaft insertion hole through which the drive shaft is inserted and which has a diameter larger than an outer diameter of the inner ring of the bearing is formed on a side of the bottom surface of the bearing accommodating portion, and
the stopper member is a nut screwed to a thread groove formed on an outer peripheral surface of the protruding portion.

11. The support structure according to claim 1, further comprising
a motor bracket provided to be slidable along a direction in which the drive pulley approaches or separates from a driven pulley around which a belt is wound together with the drive pulley, wherein
the bearing holder is provided on the motor bracket and is movable together with the motor bracket.

12. The support structure according to claim 11, wherein
the bearing holder is formed integrally with the motor bracket.

13. An industrial machine comprising:
the support structure according to claim 1;
the motor; and
the drive pulley.
